(19) United States
(12) Patent Application Publication
(10) Pub. No.: US 2010/0032856 A1
(43) Pub. Date: Feb. 11, 2010

(54) COATED FOAM BEADS AND PROCESS FOR PRODUCING HALOGEN-FREE, FIRE-RESISTANT BEAD FOAM MOLDINGS

(75) Inventors: Klaus Hahn, Kirchheim (DE); Benjamin Nehls, Ludwigshafen (DE); Bernhard Schmied, Frankenthal (DE); Michael Riethues, Ludwigshafen (DE); Andreas Keller, Bohl-Iggelheim (DE); Volker Warzelhan, Weisenheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patent, Trademarks and Licenses, Ludwigshafen (DE)

(21) Appl. No.: 12/444,731

(22) PCT Filed: Oct. 4, 2007
(86) PCT No.: PCT/EP07/60541

§ 371 Date: Apr. 8, 2009

(30) Foreign Application Priority Data
Oct. 11, 2006 (EP) 06122127.1

(51) Int. Cl. B29C 44/00; C08J 9/16

(52) U.S. Cl. 264/41; 521/56

(57) ABSTRACT

A process for producing coated foam particles, in which an aqueous polymer dispersion is applied to the foam particles and is subsequently dried to form a water-insoluble polymer film, and also foam moldings produced therefrom and their use.

The invention relates to a process for producing coated foam particles and also foam moldings produced therefrom and their use.

Particle foams are usually obtained by sintering of foam particles, for example prefoamed expandable polystyrene particles (EPS) or expanded polypropylene particles (EPP), in closed molds by means of steam.

Flame-resistant polystyrene foams are generally provided with halogen-comprising flame retardants such as hexabromocyclododecane (HBCD). However, approval as insulation materials in the building sector is restricted to particular applications. The reason for this is, inter alia, melting and dripping of the polymer matrix in the case of fire. In addition, the halogen-comprising flame retardants cannot be used without restriction because of their toxicological properties.

WO 00/050500 describes flame-resistant foams made from prefoamed polystyrene particles which are mixed with an aqueous sodium silicate solution and a latex of a high molecular weight vinyl acetate copolymer, poured into a mold and dried in air while shaking. This results in only a loose bed of polystyrene particles which are adhesively bonded to one another at few points and therefore have only unsatisfactory mechanical properties.

WO 2005/105404 describes an energy-saving process for producing foam moldings in which the prefoamed foam particles are coated with a resin solution which has a softening temperature which is lower than that of the expandable polymer. The coated foam particles are subsequently fused together in a mold with application of external pressure or by after-expansion of the foam particles by means of hot steam.

WO 2005/07331 describes expanded polystyrene foam particles having a functional coating applied by means of a solvent which does not attack the polystyrene foam particles to any substantial extent. To obtain a flame-resistant coating, the surface can be coated with, for example, a methanolic polyvinyl acetate solution comprising aluminum hydroxide particles. To prevent sticking together during removal of the solvent, the particles have to be sprayed with a separating liquid, for example ethylene glycol.

If coated foam particles are used in the customary automatic molding machines, water-soluble constituents can be leached out when steam is used.

WO 2007/013791, which is a later publication, describes the production of flame-protected composite structures by sintering of foam particles onto which a gel-forming aluminum silicate solution has been sprayed beforehand as flame retardant coating in a fluidized bed. To improve the water resistance, organic liquids such as silicone or paraffin oils can be added.

It was therefore an object of the invention to remedy the disadvantages mentioned and to provide foam particles which can be processed easily in customary apparatuses even with the aid of steam to produce halogen-free and fire- and heat-resistant foam moldings.

Accordingly, we have found a process for producing coated foam particles, in which an aqueous polymer dispersion is applied to the foam particles and is subsequently dried to form a water-insoluble polymer film.

Drying of the polymer dispersion applied to the foam particles can be effected, for example, in a fluidized bed, paddle dryer or by passing air or nitrogen through a loose bed. In general, a drying time of from 5 minutes to 24 hours, preferably from 30 to 180 minutes, at a temperature in the range from 0 to 80° C., preferably in the range from 30 to 60° C., is sufficient to form the water-insoluble polymer film.

The water content of the coated foam particles after drying is preferably in the range from 1 to 40% by weight, particularly preferably in the range from 2 to 30% by weight, very particularly preferably in the range from 5 to 15% by weight. It can be determined, for example, by Karl-Fischer titration of the coated foam particles. The weight ratio of foam particles/coating mixture after drying is preferably from 2:1 to 1:10, particularly preferably from 1:1 to 1:5.

As foam particles, it is possible to use expanded polyolefins such as expanded polyethylene (EPE) or expanded polypropylene (EPP) or prefoamed particles of expandable styrene polymers, in particular expandable polystyrene (EPS). The foam particles generally have a mean particle diameter in the range from 2 to 10 mm. The bulk density of the foam particles is generally from 5 to 100 kg/m³, preferably from 5 to 40 kg/m³ and in particular from 8 to 16 kg/m³, determined in accordance with DIN EN ISO 60.

The foam particles based on styrene polymers can be obtained by prefoaming EPS to the desired density by means of hot air or steam in a prefoamer. Here, final bulk densities below 10 g/l can be obtained by means of simple or multiple prefoaming in a pressure prefoamer or continuous prefoamer.

Owing to their high thermal insulation capability, particular preference is given to using prefoamed, expandable styrene polymers which comprise athermanous solids such as carbon black, aluminum or graphite, in particular graphite having a mean particle size in the range from 1 to 50 μm particle diameter, in amounts of from 0.1 to 10% by weight, in particular from 2 to 8% by weight, based on EPS, and are known, for example, from EP-B 981 574 and EP-B 981 575.

Furthermore, the foam particles of the invention can comprise from 3 to 60% by weight, preferably from 5 to 20% by weight, based on the prefoamed foam particles, of a filler. Possible fillers are organic and inorganic powders or fibers and also mixtures thereof. As organic fillers, it is possible to use, for example, wood flour, starch, flax, hemp, ramie, jute, sisal, cotton, cellulose or aramid fibers. As inorganic fillers, it is possible to use, for example, carbonates, silicates, barite, glass spheres, zeolites or metal oxides. Preference is given to pulverulent inorganic materials such as talc, chalk, kaolin (Al₂(Si₂O₅)(OH)₄), aluminum hydroxide, magnesium hydroxide, aluminum nitride, aluminum silicate, barium sulfate, calcium carbonate, calcium sulfate, silica, quartz flour, Aerosil, alumina or wollastonite or spherical or fibrous inorganic materials such as glass spheres, glass fibers or carbon fibers.

The mean particle diameter or in the case of fibrous fillers the length should be in the region of the cell size or smaller. Preference is given to a mean particle diameter in the range from 1 to 100 μm, preferably in the range from 2 to 50 μm.

Particular preference is given to inorganic fillers having a density in the range 1.0-4.0 g/cm³, in particular in the range 1.5-3.5 g/cm³. The degree of whiteness/brightness (DIN/ISO) is preferably 50-100%, in particular 60-98%.

The type and amount of the fillers can influence the properties of the expandable thermoplastic polymers and the particle foam moldings obtainable therefrom. The use of bonding agents such as styrene copolymers modified with maleic anhydride, polymers comprising epoxide groups, organosilanes or styrene copolymers having isocyanate or acid groups enables the bonding of the filler to the polymer matrix and thus the mechanical properties of the particle foam moldings to be significantly improved.

In general, inorganic fillers reduce the combustibility. The burning behavior can be improved further by, in particular, addition of inorganic powders such as aluminum hydroxide, magnesium hydroxide or borax.

Such filler-comprising foam particles can be obtained, for example, by foaming of filler-comprising, expandable thermoplastic pellets. At high filler contents, the expandable pellets required for this purpose can be obtained by extrusion of thermoplastic melts comprising blowing agent and subsequent underwater pressure pelletization as described, for example, in WO 2005/056653.

The polymer foam particles can additionally be provided with further flame retardants. They can for this purpose comprise, for example, from 1 to 6% by weight of an organic bromine compound such as hexabromocyclododecane (HBCD) and, if appropriate, an additional 0.1-0.5% by weight of bicumyl or a peroxide either in the interior of the foam particles or the coating. However, preference is given to using no halogen-comprising flame retardants.

In general, the coating comprises a polymer film which has one or more glass transition temperatures in the range from −60° to +100° C. and in which fillers may, if appropriate, be embedded. The glass transition temperatures of the dried polymer film are preferably in the range from −30° to +80° C., particularly preferably in the range from −10° to +60° C. The glass transition temperature can be determined by means of differential scanning calorimetry (DSC). The molecular weight of the polymer film determined by gel permeation chromatography (GPC) is preferably below 400 000 g/mol.

To coat the foam particles, it is possible to use customary methods such as spraying, dipping or wetting of the foam particles with an aqueous polymer dispersion in customary mixers, spraying apparatuses, dipping apparatuses or drum apparatuses.

Polymers suitable for the coating are, for example, polymers based on monomers such as vinylaromatic monomers, e.g. α-methylstyrene, p-methylstyrene, ethylstyrene, tert-butylstyrene, vinylstyrene, vinyltoluene, 1,2-diphenylethylene, 1,1-diphenylethylene, alkenes such as ethylene or propylene, dienes such as 1,3-butadiene, 1,3-pentadiene, 1,3-hexadiene, 2,3-dimethylbutadiene, isoprene, piperylene or isoprene, α,β-unsaturated carboxylic acids such as acrylic acid and methacrylic acid, their esters, in particular alkyl esters, e.g. C₁₋₁₀-alkyl esters of acrylic acid, in particular the butyl esters, preferably n-butyl acrylate, and the C₁₋₁₀-alkyl esters of methacrylic acid, in particular methyl methacrylate (MMA) or carboxamides, for example acrylamide and methacrylamide.

The polymers can, if appropriate, comprise from 1 to 5% by weight of comonomers such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide or the sodium salt of vinylsulfonic acid.

The polymers of the coating are preferably composed of one or more of the monomers styrene, butadiene, acrylic acid, methacrylic acid, C₁₋₄-alkyl acrylates, C₁₋₄-alkyl methacrylates, acrylamide, methacrylamide and methylolacrylamide.

Suitable binders for the polymer coating are, in particular, acrylate resins which, according to the invention, are applied as aqueous polymer dispersions to the foam particles, if appropriate together with hydraulic binders based on cement, lime cement or gypsum plaster. Suitable polymer dispersions can be obtained, for example, by free-radical emulsion polymerization of ethylenically unsaturated monomers such as styrene, acrylates or methacrylates, as described in WO 00/50480.

Particular preference is given to pure acrylates or styrene-acrylates composed of the monomers styrene, n-butyl acrylate, methyl methacrylate (MMA), methacrylic acid, acrylamide or methylolacrylamide.

The polymer dispersion is prepared in a manner known per se, for instance by emulsion, suspension or dispersion polymerization, preferably in an aqueous phase. The polymer can also be prepared by solution or bulk polymerization, be comminuted if appropriate and the polymer particles can subsequently be dispersed in water in a customary fashion. The polymerization is carried out using the initiators, emulsifiers or suspension aids, regulators or other auxiliaries customary for the respective polymerization process and is carried out continuously or batchwise at the temperatures and pressures customary for the respective process in conventional reactors.

The polymer coating can also comprise additives such as inorganic fillers, e.g. pigments, or flame retardants. The proportion of additives depends on their type and the desired effect and for inorganic fillers is generally from 10 to 99% by weight, preferably from 20 to 98% by weight, based on the additive-comprising polymer coating.

The coating mixture preferably comprises water-binding substances such as water glass. This leads to a better or more rapid film formation from the polymer dispersion and thus to more rapid curing of the foam molding.

The polymer coating preferably comprises flame retardants such as expandable graphite, borates, in particular zinc borates, melamine compounds or phosphorus compounds or intumescent compositions which expand, swell or foam at relatively high temperatures, generally above 80-100° C., and thus form an insulating and heat-resistant foam which protects the underlying thermally insulating foam particles from fire and heat. The amount of flame retardants or intumescent compositions is generally from 2 to 99% by weight, preferably from 5 to 98% by weight, based on the polymer coating.

When flame retardants are used in the polymer coating, it is also possible to achieve satisfactory fire protection when using foam particles which comprise no flame retardants, in particular no halogenated flame retardants, or make do with relatively small amounts of flame retardants, since the flame retardant in the polymer coating is concentrated on the surface of the foam particles and forms a strong framework under the action of heat or fire.

The polymer coating particularly preferably comprises intumescent compositions which comprise chemically bound water or eliminate water at temperatures above 40° C., e.g. alkali metal silicates, metal hydroxides, metal salt hydrates and metal oxide hydrates, as additives.

Foam particles provided with this coating can be processed to give foam moldings having increased fire resistance. Depending on the amount of the coating, the foam bodies according to the invention can be classified as building material class B1 or A2 in accordance with DIN 4102 or the Euro classes A2, B and C in accordance with the European fire protection classification DIN EN 13501-1.

Suitable metal hydroxides are, in particular, those of groups 2 (alkaline earth metals) and 13 (boron group) of the Periodic Table. Preference is given to magnesium hydroxide, aluminum hydroxide and borax. Particular preference is given to aluminum hydroxide.

Suitable metal salt hydrates are all metal salts in which water of crystallization is incorporated in the crystal structure. Analogously, suitable metal oxide hydrates are all metal oxides which comprise water of crystallization incorporated into the crystal structure. Here, the number of molecules of water of crystallization per formula unit can be the maximum possible number or below this, e.g. copper sulfate pentahydrate, trihydrate or monohydrate. In addition to the water of crystallization, the metal salt hydrates or metal oxide hydrates can also comprise water of constitution.

Preferred metal salt hydrates are the hydrates of metal halides (in particular chlorides), sulfates, carbonates, phosphates, nitrates or borates. Examples of suitable metal salt hydrates are magnesium sulfate decahydrate, sodium sulfate decahydrate, copper sulfate pentahydrate, nickel sulfate heptahydrate, cobalt(II) chloride hexahydrate, chromium(III) chloride hexahydrate, sodium carbonate decahydrate, magnesium chloride hexahydrate and the tin borate hydrates. Magnesium sulfate decahydrates and tin borate hydrates are particularly preferred.

Further possible metal salt hydrates are double salts or alums, for example those of the general formula: M^{I}M^{III}(SO₄)₂.12H₂O. M^{I} can be, for example, potassium, sodium, rubidium, cesium, ammonium, thallium or aluminum ions. Elements which can function as M^{III} are, for example, aluminum, gallium, indium, scandium, titanium, vanadium, chromium, manganese, iron, cobalt, rhodium or iridium.

Suitable metal oxide hydrates are, for example, aluminum oxide hydrate and preferably zinc oxide hydrate or boron trioxide hydrate.

A preferred polymer coating can be obtained by mixing
a) from 40 to 80 parts by weight, preferably from 50 to 70 parts by weight, of a water glass solution having a water content of from 40 to 90% by weight, preferably from 50 to 70% by weight,
b) from 20 to 60 parts by weight, preferably from 30 to 50 parts by weight, of a water glass powder having a water content of from 0 to 30% by weight, preferably from 1 to 25% by weight, and
c) from 5 to 40 parts by weight, preferably from 10 to 30 parts by weight, of a polymer dispersion having a solids content of from 10 to 60% by weight, preferably from 20 to 50% by weight, or by mixing
a′) from 20 to 95 parts by weight, preferably from 40 to 90 parts by weight, of an aluminum hydroxide suspension having an aluminum hydroxide content of from 10 to 90% by weight, preferably from 20 to 70% by weight,
b′) from 5 to 40 parts by weight, preferably from 10 to 30 parts by weight, of a polymer dispersion having a solids content of from 10 to 60% by weight, preferably from 20 to 50% by weight.

Furthermore, the coating can comprise fillers, in particular IR-absorbing fillers. Fillers having particle sizes in the range from 0.1 to 100 μm, in particular in the range from 0.5 to 10 μm, in proportions of 10% by weight in the polystyrene foam give a decrease in the thermal conductivity by from 1 to 3 mW. Comparatively low thermal conductivities can therefore be achieved at relatively small amounts of IR absorbers such as carbon black and graphite.

To reduce the thermal conductivity, an IR absorber such as carbon black, coke, aluminum or graphite is preferably used in amounts of from 0.1 to 10% by weight, in particular in amounts of from 2 to 8% by weight, based on the solids of the coating.

Preference is given to using carbon black having a mean primary particle size in the range from 10 to 300 nm, in particular in the range from 30 to 200 nm. The BET surface area is preferably in the range from 10 to 120 m²/g.

As graphite, preference is given to using graphite having a mean particle size in the range from 1 to 50 μm.

Furthermore, the foam particles of the invention can be coated with amphiphilic or hydrophobic organic compound. Coating with hydrophobicizing agent is advantageously carried out before application of the aqueous polymer dispersion according to the invention. Among hydrophobic organic compounds, mention may be made of, in particular, C₁₀-C₃₀-paraffin waxes, reaction products of N-methylolamine and a fatty acid derivative, reaction products of a C₉-C₁₁ oxo alcohol with ethylene oxide, propylene oxide or butylene oxide or polyfluoroalkyl (meth)acrylates or mixtures thereof, which can preferably be used in the form of aqueous emulsions.

Preferred hydrophobicizing agents are paraffin waxes which have from 10 to 30 carbon atoms in the carbon chain and preferably have a melting point in the range from 10 to 70° C., in particular from 25 to 60° C. Such paraffin waxes are comprised, for example, in the commercial BASF products RAMASIT KGT, PERSISTOL E and PERSISTOL HP and in AVERSIN HY-N from Henkel and CEROL ZN from Sandoz.

Another class of suitable hydrophobicizing agents is made up of resin-like reaction products of an N-methylolamine with a fatty acid derivative, e.g. a fatty acid amide, amine or alcohol, as described, for example, in U.S. Pat. No. 2,927,090 or GB-A 475 170. Their melting point is generally from 50 to 90° C. Such resins are comprised, for example, in the commercial BASF product PERSISTOL HP and in ARCOPHOB EFM from Hoechst.

Finally, polyfluoroalkyl (meth)acrylates, for example polyperfluorooctyl acrylate, are also suitable. This substance is comprised in the commercial BASF product PERSISTOL O and in OLEOPHOBOL C from Pfersee.

Further possible coating agents are antistatics such as Emulgator K30 (mixture of secondary sodium alkanesulfonates) or glyceryl stearates such as glyceryl monostearate GMS or glyceryl tristearate. However, in the process of the invention the coating agents customary for the coating of expandable polystyrene, in particular stearates, can be used in reduced amounts or be omitted entirely without this having an adverse effect on the product quality.

The foam particles which have been coated according to the invention can be sintered by means of hot air or steam in conventional molds to give foam moldings.

In the sintering or conglutination of the foam particles, the pressure can be generated, for example, by reducing the volume of the mold by means of a movable punch. In general, a pressure in the range from 0.5 to 30 kg/cm² is set here. The mixture of coated foam particles is for this purpose introduced into the open mold. After closing the mold, the foam particles are pressed by means of the punch, with the air between the foam particles escaping and the volume of the interstices being reduced. The foam particles are bonded by the polymer coating to give the foam molding.

The mold is configured according to the desired geometry of the foam body. The degree of fill depends, inter alia, on the desired thickness of the future molding. In the case of foam boards, a simple box-shaped mold can be used. Particularly in the case of more complicated geometries, it can be necessary to densify the bed of particles introduced into the mold and to eliminate undesirable voids in this way. Densification can be effected, for example, by shaking of the mold, tumbling movements or other suitable measures.

To accelerate bonding, hot air or steam can be injected into the mold or the mold can be heated. The heating of the mold can, however, be achieved using any heat transfer media such as oil or steam. The hot air or the mold is for this purpose advantageously heated to a temperature in the range from 20 to 120° C., preferably from 30 to 90° C.

As an alternative or in addition, sintering can be carried out continuously or discontinuously with introduction of microwave energy. Here, microwaves in the frequency range from 0.85 to 100 GHz, preferably from 0.9 to 10 GHz, and irradiation times of from 0.1 to 15 minutes are generally used. Foam boards having a thickness of more than 5 cm can also be produced by this means.

When hot air or steam at temperatures in the range from 80 to 150° C. is used or microwave energy is introduced, a gauge pressure of from 0.1 to 1.5 bar is usually established, so that the process can also be carried out without external pressure and without a reduction in the volume of the mold. The internal pressure produced by the microwaves or elevated temperatures allows the foam particles to expand a little further, so that the particles can fuse together as a result of softening of the foam particles themselves in addition to conglutination via the polymer coating. The interstices between the foam particles disappear as a result. To accelerate bonding, the mold can in this case, too, be additionally heated by means of a heat transfer medium as described above.

For continuous production of the foam moldings, double belt plants as are used for producing polyurethane foams are also suitable. For example, the prefoamed and coated foam particles can be applied continuously to the lower belt of two metal belts, which can have a perforation if appropriate, and processed with or without compression by the metal belts which run together to produce continuous foam boards. At a high compression pressure, metal link chains are preferably used.

A double belt unit having a lower belt and an upper belt which moves synchronously with the lower belt, as described, for example, in WO 02/26457 for producing inorganic foams, is also suitable. The lower belt of the double belt unit comprises a plurality of segments whose cross section determines the upper region and the two lateral regions of the foam profile. In a subregion of the double belt unit, the upper belt dips in a sealing fashion into the segments of the lower belt, so that this subregion of the double belt unit forms a closed space which is sealed on all sides. The segments of the upper belt and the lower belt are preferably made of stainless steel.

In one embodiment of the process, the volume between the two belts is made increasingly smaller so that the product between the belts is compressed and the interstices between the foam particles disappear. After a curing zone, a continuous board is obtained. In another embodiment, the volume between the belts can be kept constant and the product is passed through a zone with hot air or microwave irradiation in which the foam particles foam further. Here too, the interstices disappear and a continuous board is obtained. It is also possible to combine the two continuous process variants.

In the case of a double belt unit having metal belts, the microwaves are preferably injected laterally into the gap between the upper and lower metal belts. In another embodiment, the metal belt section can end after compression is complete and further transport and maintenance of the shape of the continuous foam board is taken over by a downstream system comprising likewise continuous, coated natural or synthetic fiber belts which can be radiated with microwaves both via the gap at the side and also over their area through the natural or synthetic fiber belts.

The thickness, length and width of the foam boards can vary within wide limits and is limited by the size and closure force of the tool. The thickness of the foam boards is usually from 1 to 500 mm, preferably from 10 to 300 mm.

The density of the foam moldings in accordance with DIN 53420 is generally from 10 to 120 kg/m³, preferably from 20 to 90 kg/m³. The process makes it possible to obtain foam moldings having a uniform density over the entire cross section. The density of the outer layers corresponds approximately to the density in the inner regions of the foam molding.

Comminuted foam particles from recycled foam moldings can also be used in the process. To produce the foam moldings according to the invention, the comminuted recycled foam can be used to an extent of 100% or, for example, in proportions of from 2 to 90% by weight, in particular from 5 to 25% by weight, together with fresh material without significantly impairing the strength and the mechanical properties.

A preferred process comprises the steps:
i) prefoaming of expandable styrene polymers to form foam particles,
ii) application of an aqueous polymer dispersion to the foam particles,
iii) drying of the polymer dispersion to form a water-insoluble polymer film,
iv) introduction of the foam particles coated with the polymer film into a mold and sintering.

The process is suitable for producing simple or complex foam moldings such as boards, blocks, tubes, rods, profiles, etc. Preference is given to producing boards or blocks which can subsequently be sawn or cut to give boards. They can be used, for example, in building and construction for the insulation of exterior walls. They are particularly preferably used as core layer for producing sandwich elements, for example structural insulation panels (SIPs), which are used for the erection of coolstores or warehouses.

Further possible applications are pallets made of foam as replacement for wooden pallets, fascia boards, insulated containers, trailers. Owing to the excellent fire resistance, they are also suitable for air freight.

### EXAMPLES

### Production of the Coating Mixture BM1

40 parts of water glass powder (Portil N) were added a little at a time while stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 5 parts of an acrylate dispersion (Acronal S790, solids content: about 50%) were subsequently stirred in.

Production of the Coating Mixture BM2:

40 parts of water glass powder (Portil N) were added a little at a time while stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 20 parts of an acrylate dispersion (Acronal S790, solids content: about 50%) were subsequently stirred in.

Polystyrene Foam Particles (Density: 17 g/l)

Expandable polystyrene (Neopor) 2300 from BASF Aktiengesellschaft, bead size of the raw material: 1.4-2.3 mm) was prefoamed to a density of about 17 g/l on a continuous prefoamer.

### Examples 1-4

The polystyrene foam particles were coated with the coating mixture BM1 or BM2 in a weight ratio of 1:4 or 1:5, respectively, in a mixer and subsequently dried by laying out in air for 12 hours. The coated polystyrene foam particles were introduced into a Teflon-coated mold and treated with steam at 0.5 bar gauge pressure for 30 seconds by means of steam nozzles. The molding was taken from the mold and stored at ambient temperature for a number of days to condition it further. The density of the stored molding was 50 g/l.

TABLE 1

| | | Weight ratio of EPS/ |
|---|---|---|
| | Coating mixture | coating mixture |
| Example 1 | BM 1 | 1:5 |
| Example 2 | BM 2 | 1:5 |
| Example 3 | BM 1 | 1:4 |
| Example 4 | BM 1 | 1:5 |

The foam moldings of examples 1 to 4 do not drip in the burning test and do not soften back under the action of heat. They are self-extinguishing.

1-10. (canceled)

11. A process for producing foam moldings, which comprises the steps
i) prefoaming of expandable styrene polymers to form foam particles,
ii) application of an aqueous polymer dispersion to the foam particles,
iii) drying of the polymer dispersion to form a water-insoluble polymer film,
iv) introduction of the foam particles coated with the polymer film into a mold and sintering.

12. The process according to claim 11, wherein drying of the polymer dispersion applied to the foam particles is effected by means of air or nitrogen at a temperature in the range from 0 to 80° C.

13. The process according to claim 11, wherein an aqueous polymer dispersion obtained by mixing
a) from 40 to 80 parts by weight of a water glass solution having a water content of from 40 to 90% by weight,
b) from 20 to 60 parts by weight of a water glass powder having a water content of from 0 to 30% by weight and
c) from 5 to 40 parts by weight of an aqueous polymer dispersion having a solids content of from 10 to 60% by weight is used.

14. The process according to claim 11, wherein the dried polymer film has a glass transition temperature in the range from −60 to +60° C.

15. The process according to claim 11, wherein a free-radical emulsion polymer of ethylenically unsaturated monomers is used as an aqueous polymer dispersion.

16. The process according to claim 11, wherein the weight ratio of foam particles/coating mixture after drying is from 2:1 to 1:10.

17. The process according to claim 11, wherein the density of the foam moldings in accordance with DIN 53420 is from 10 to 120 Kg/m³.

18. The process according to claim 17, wherein sintering is carried out under a pressure in the range from 0.5 to 30 kg/cm².

19. The process according to claim 17, wherein sintering is effected with introduction of microwave energy.

20. The process according to claim 17, wherein hot air or steam is injected into the mold.

21. The process according to claim 12, wherein an aqueous polymer dispersion obtained by mixing
a) from 40 to 80 parts by weight of a water glass solution having a water content of from 40 to 90% by weight,
b) from 20 to 60 parts by weight of a water glass powder having a water content of from 0 to 30% by weight and
c) from 5 to 40 parts by weight of an aqueous polymer dispersion having a solids content of from 10 to 60% by weight is used.

22. The process according to claim 12, wherein the dried polymer film has a glass transition temperature in the range from −60 to +60° C.

23. The process according to claim 13, wherein the dried polymer film has a glass transition temperature in the range from −60 to +60° C.

24. The process according to claim 12, wherein a free-radical emulsion polymer of ethylenically unsaturated monomers is used as an aqueous polymer dispersion.

25. The process according to claim 13, wherein a free-radical emulsion polymer of ethylenically unsaturated monomers is used as an aqueous polymer dispersion.

26. The process according to claim 14, wherein a free-radical emulsion polymer of ethylenically unsaturated monomers is used as an aqueous polymer dispersion.

27. The process according to claim 12, wherein the weight ratio of foam particles/coating mixture after drying is from 2:1 to 1:10.

28. The process according to claim 13, wherein the weight ratio of foam particles/coating mixture after drying is from 2:1 to 1:10.

29. The process according to claim 14, wherein the weight ratio of foam particles/coating mixture after drying is from 2:1 to 1:10.

30. The process according to claim 15, wherein the weight ratio of foam particles/coating mixture after drying is from 2:1 to 1:10.
